(19) United States
(12) Patent Application Publication
(10) Pub. No.: US 2003/0140185 A1
(43) Pub. Date: Jul. 24, 2003

(54) Method and system for client-side print job meta-data collection and open billing

(76) Inventors: Darrel Cherry, Boise, ID (US); James Clough, Boise, ID (US)

Correspondence Address: HEWLETT-PACKARD COMPANY, Intellectual Property Adiministration, P.O. Box 272400, Fort Collins, CO, 80527-2400, US

(21) Appl. No.: 10/054,420

(22) Filed: Jan. 22, 2002

(51) Int. Cl. G06F 3/00

(52) U.S. Cl. 710/15

(57) ABSTRACT

A method and system for client-side print job meta-data collection and client billing for gathering print job and a client identifier to be associated with the print job. Print job data may be, for example and not by way of limitation, the number of copies pages, type and/or size of paper and the like. Also, a method and system for converting the print job data and client identifier at a client computer into meta-data for transmission with the print job to a printer. An method and system for performing the print job and extracting the meta-data for billing a client is further included.

### FIELD OF THE INVENTION

The present invention relates generally to image processing devices. More specifically, the invention includes a method and system for gathering information necessary to bill a client for performing a print job.

### BACKGROUND OF THE INVENTION

High-speed photocopy and printing machines are ubiquitous in modem businesses today. While the cost for delivering a printed page has continually dropped, there is still a finite cost associated with making a photocopy or printing a page of a document. There are numerous businesses that are based on performing document reproduction or printing for their customers. Such document reproduction or printing services are typically billed on a per page basis. Additionally, many other service-based industries pass the cost of photocopies and/or printed pages on to the customer in addition to whatever billable service they may also provide. In all of these instances, there has been a need to accurately track the number of copies or printed pages that were generated and associate that number with a particular client for billing purposes.

One approach in the context of photocopy machines has been to provide coin operated or debit card operated photocopy machines for self-service customers to pay for copies on a realtime basis. According to this approach, a user deposits money or a debit card into a controller attached to the photocopy machine that automatically deducts the per page charge from the user's credit balance. Copy centers that allow self-service photocopying often use a counter that performs two functions: activating the photocopy machine and also counting the number of pages copied. According to this method, the user checks out the counter and then returns it after use and pays for the number of copies made. One such copy service accounting device is disclosed in U.S. Pat. No. 5,357,090 to Masai.

However, neither of these approaches is particularly suitable for tracking and billing a customer that is not present during the actual copying process and therefore able to pay for the service at that time. Thus, another solution in the context of a copy center is for the customer to provide the originals, either hard copy or on a disk to the copy center personnel. The copy center personnel will then perform the copy or print work keeping track of the number of copies made using a counter or other means and then bill the customer when the customer picks up the copies and/or print job. Keeping track of the print job may be performed with a paper form with the customer's name and the description of the job and may also include the total cost for the job.

A more sophisticated approach is disclosed in U.S. Pat. No. 5,146,344 to Bennett et al. Bennett et al. discloses a printing system that provides a facility for setting up customer accounts and billing rates associated with various system functions within each account. The Bennett et al. system provides for facilities for generating statistical and billing reports. However, the Bennett et al. system appears to require all customer account setup and functions to be performed by a system operator physically collocated with the device.

Yet another approach to the problem, and one that is frequently found in service-based businesses, such as law firms, is to use an event counter that is interfaced to the photocopy or printing machine. For example, U.S. Pat. No. 4,531,826 to Stoughton et al. discloses an event counter and access controller that includes a keyboard and display. A user of the Stoughton et al. device may be required to enter a user number by the keyboard to provide access to a photocopy or printing machine and automatically keep track of the number of photocopies or printed pages generated and associate that number with the user number for billing purposes. The user number may be a client and/or matter number for billing a third party. However, the Stoughton et al. device must be interfaced with the particular photocopy or printing machine. Additionally, the user must manually enter the user number at the keyboard, which is typically situated near the photocopy or printing machine.

Still another approach is disclosed in U.S. Pat. No. 6,216,113 B1 to Aikens et al. Aikens et al. discloses a system for accumulating billing data for printing machines interconnected to multiple work stations on the network. The Aikens et al. system includes a network administrator for storing data representing usage of selected printers and validating print job requests and billing account numbers. However, Aikens et al. does not appear to convert billing information or print job data associated with the print job into meta-data. Additionally, Aikens et al. does not appear to disclose the use of meta-data appended to the print job at the client computer prior to sending to the printer.

Even another approach is disclosed in U.S. Pat. No. 6,233,631 B1 to Dombrowski et al. Dombrowski et al. discloses a method of uploading and downloading of printer usage information to a PC for conversion to ASCII or Microsoft® Excel™ formats. However, Dombrowski et al. does not appear to convert billing information or print job data associated with the print job into meta-data. Additionally, Dombrowski et al. does not appear to disclose the use of meta-data appended to the print job at the client computer prior to sending to the printer.

It would be advantageous to gather print job data and a client identifier to be associated with the print job, convert the print job data and client identifier at the client computer into meta-data for transmission with the print job to a printer, where the printer can perform the print job and extract the meta-data for billing a client. For the above reasons, there exists a need in the art for a method and system for client-side print job meta-data collection and client billing.

### SUMMARY OF THE INVENTION

The present invention includes a method and system for client-side print job meta-data collection and client billing. The present invention provides a method and system for gathering print job data and a client identifier to be associated with the print job. Print job data may be, for example and not by way of limitation, the number of copies, pages, type and/or size of paper and the like. The present invention further includes a method and system for converting the print job data and client identifier at a client computer into meta-data for transmission with the print job to a printer. The present invention may further include a method and system for performing the print job and extracting the meta-data for billing a client.

A method for client-side print job meta-data collection and client billing in accordance with the present invention may include capturing print job data associated with a print job during execution of a print command and converting the print job data into meta-data. The method of the present invention may also include combining the meta-data with the print job to form an enhanced print job, sending the enhanced print job to an imaging device and extracting the meta-data from the enhanced print job for client billing. The method of the present invention may also include billing a client in accordance with the extracted meta-data.

A system for client-side print job meta-data collection and client billing in accordance with the present invention may include a client computer configured for capturing print job data associated with a print job during execution of a print command, converting the print job data into meta-data, combining the meta-data with the print job to form an enhanced print job, and sending the enhanced print job to an imaging device. The system of the present invention may also include an imaging device in communication with the client computer and configured for receiving the enhanced print job extracting and printing the print job from the enhanced print job and extracting metadata from the enhanced print job for billing a client. The system of the present invention may further include a billing computer in communication with the server printer for receiving the meta-data from the server printer and configured for generating billing data.

In accordance with another aspect of the present invention, an imaging system is configured for communication with a client computer over a network and configured for receiving an enhanced print job, extracting meta-data from the enhanced print job for billing a client and printing a print job from the enhanced print job.

These methods, apparatuses and systems of the present invention will be readily understood by reading the following detailed description in conjunction with the accompanying drawings.

### DESCRIPTION OF THE DRAWINGS

FIG. 1 is a flow chart of a method for client-side print job meta-data collection and client billing in accordance with the present invention; and

FIG. 2 is a block diagram of a system for client-side print job meta-data collection and client billing in accordance with the present invention.

### DETAILED DESCRIPTION OF THE INVENTION

The present invention includes a method and system for client-side print job meta-data collection and client billing. The present invention provides a method and system for gathering print job data and a client identifier to be associated with the print job. Print job data may be, for example and not by way of limitation, the number of copies, pages, type and/or size of paper and the like. The present invention further includes a method and system for converting the print job data and client identifier at a client computer into meta-data for transmission with the print job to a printer. The present invention may further include a method and system for performing the print job and extracting the meta-data for billing a client. The term “print job”, as used herein, refers to one or more data files suitable for reading by an imaging device that will generate a printed output.

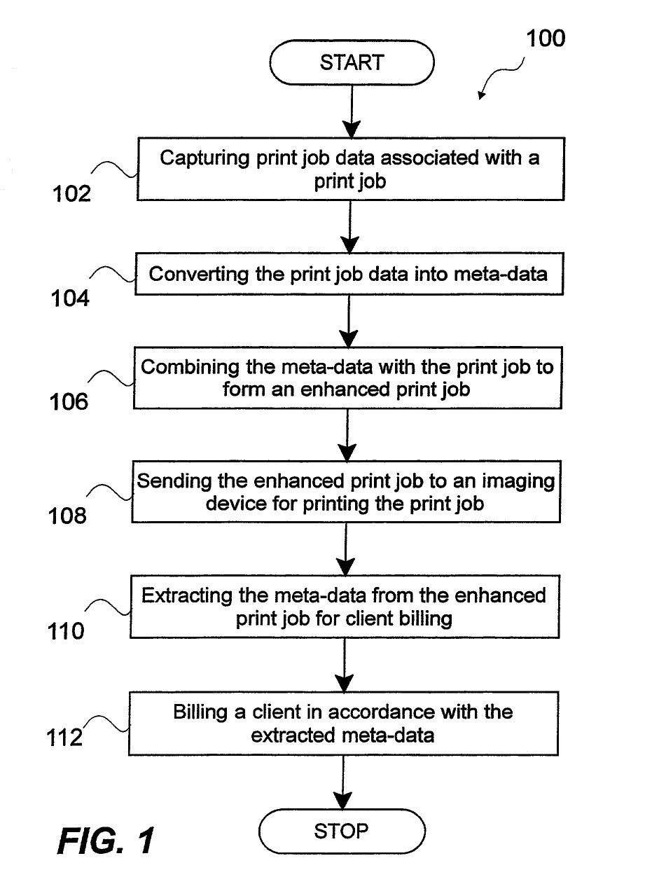

FIG. 1 is a flow chart of a method 100 for client-side print job meta-data collection and client billing in accordance with the present invention. Method 100 includes capturing 102 print job data associated with a print job. Print job data may include, for example and not by way of limitation, the number of copies of a file or files to be printed, the number of pages of each file or files to be printed and the type and/or size of paper used to print each page. Moreover, the print job data may also include a client identifier for billing purposes. The client identifier may be an alphanumeric string used to identify a predefined customer. The client identifier may also include an alphanumeric string used to identify a matter or other subdivision of the predefined customer. The print job may comprise more than one computer file.

Capturing 102 print job data associated with a print job may include entering print job data into a pop-up window on the screen of a client computer issuing the print command. Various data entry screens or formats may be used to capture print job data, for example, printing from within an application using standard dialogs from the operating system may be used to capture print job data. Additionally, such existing or standard processes may be modified to include entry of one or more client identifiers. Alternatively, an additional or separate process may be used to prompt the user to enter the one or more client identifiers. Such an additional or separate process may also use a pop-up window. The use and configuration of such data entry screens or pop-up windows are within the knowledge of one of ordinary skill in the art.

The client identifier may be used to associate a weighted cost reflective of the print job based on the particular print job data for a given print job. Of course, various weighting or billing strategies are well known to one of ordinary skill in the art. For example, and not by way of limitation, various billing rates may depend upon the size of the paper sheets required, color requirements, paper type or stock requirements, and duplex versus simplex printing.

Method 100 may also include converting 104 the print job data into meta-data. As known to one of ordinary skill in the art, meta-data is “data about data.” Generally, meta-data may describe how and when and by whom a particular set of data was collected and how the data is formatted. In the context of the present invention, meta-data may include any kind of print job data. As stated above, the print job data may include a client identifier. The combination of print job data with a client identifier is necessary for billing a client for a print job. Meta-data may take any form consistent with the present invention. For example and not by way of limitation, meta-data may be found in a markup language. A presently preferred format for meta-data consistent with the present invention is extensible markup language (XML).

Extensible markup language (XML) provides a standard or data structure for structured authoring. XML is a subset of the Standardized General Markup Language (SGML) tailored specifically for the Internet. XML includes facilities for meta-data. Version 1.0 (Second Edition) of the XML standard, as recommended by the World Wide Web Consortium (W3C), is available on the Internet at: http://www.w3.org./TR/REC-xml as of Oct. 6, 2000, the contents of which are herein incorporated by reference.

Method 100 may further include combining 106 the meta-data with the print job to form an enhanced print job. For example and not by way of limitation, the print job may form the body of an XML file and the print job data may be meta-data within the XML file. The XML file may form the enhanced print job consistent with the present invention.

Method 100 may further include sending 108 the enhanced print job to an imaging device for printing the print job. Sending 108 may be performed over a network using transmission control protocol / Internet protocol (TCP/IP) or any other suitable packet-based transmission. The network may be a local area network (LAN), a wide area network (WAN), the public Internet, or a private Internet. The imaging device may be a networked printer of any sort. Alternatively, the imaging device may be capable of performing as a photocopy machine, a facsimile machine or printer or any combination thereof.

Method 100 may further include extracting 110 the meta-data from the enhanced print job for client billing. The extracting 110 of meta-data may be performed by the imaging device performing the print job. Alternatively, extracting 110 of the meta-data from the enhanced print job may be performed by a separate computer, such as, for example and not by way of limitation, a billing computer. Extracting 110 may include converting the meta-data into a format suitable for use by separate billing software. Some such methods of converting printer usage information into another format are disclosed in U.S. Pat. No. 6,233,631 B1 to Dombrowski et al.

Method 100 may further include billing 112 a client in accordance with the print job data embedded in the meta-data. Billing 112 may be performed directly by the imaging device receiving the meta-data and executing the print job. Alternatively, billing 112 may be performed by a billing computer or even a client computer. The billing computer may be in communication with the imaging device and the client computer that originated the print command through a network.

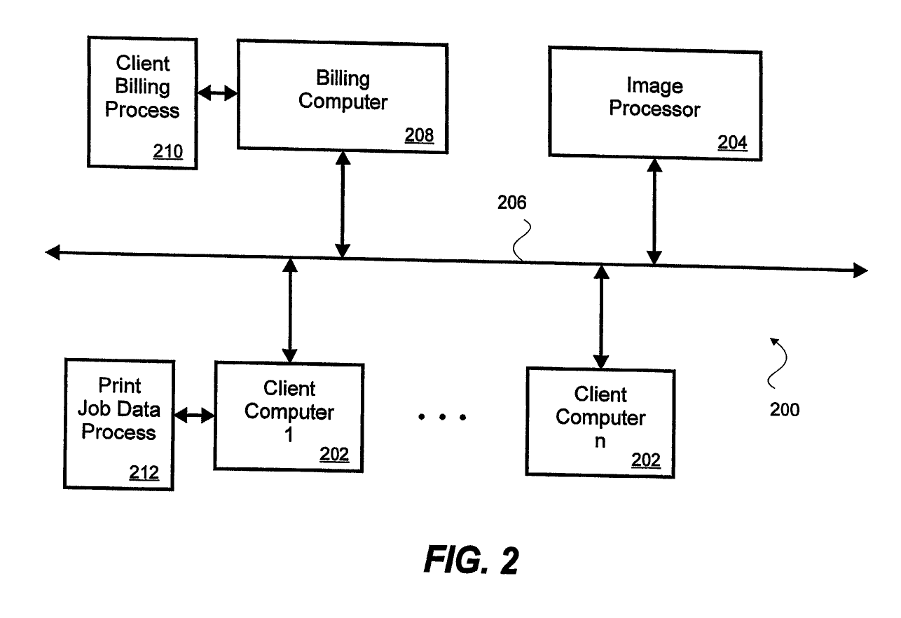

FIG. 2 is a block diagram of a system 200 for client-side print job meta-data collection and client billing in accordance with the present invention. System 200 may include at least one client computer 202 (two shown in FIG. 2) and an image processor 204. Each client computer 202 may communicate with the image processor 204 over a network 206. Network 206 may be a local area network (LAN), a wide area network (WAN), the public Internet, or a private Internet. System 200 may also include a billing computer 208 in communication with the image processor 204. Billing computer 208 may include a client billing process 210 for receiving print job data including a client identifier and generating bills or invoices to mail to a client based on the print job performed.

Client billing process 210 may alternatively run on any suitable processor, such as a client computer 202 or on the image processor itself. Client billing process 210 may include software and/or hardware and/or firmware. Client billing process 210 may be stored as computer instructions on a hard disk or other bulk storage medium, in volatile semiconductor memory such as a dynamic random access memory (DRAM) or on nonvolatile semiconductor memory such as read only memory (ROM).

System 200 may also include a print job data process 212 running on any client computer 202 for capturing print job data including a client identifier for each print job. Print job data process 210 may be stored as computer instructions on a hard disk or other bulk storage medium, in volatile semiconductor memory such as a dynamic random access memory (DRAM) or on nonvolatile semiconductor memory such as read only memory (ROM).

Although this invention has been described with reference to particular embodiments, the invention is not limited to these described embodiments. Rather, the invention is limited only by the appended claims, which include within their scope all equivalent devices or methods that operate according to the principles of the invention as described herein.

What is claimed is:

1. A method for client-side print job meta-data collection and client billing comprising:
capturing print job data associated with a print job during execution of a print command;
converting said print job data into meta-data;
combining said meta-data with said print job to form an enhanced print job;
sending said enhanced print job to an imaging device; and
extracting said meta-data from said enhanced print job for client billing.

2. The method of claim 1, wherein said print job data includes a client identifier associated with said print job.

3. The method of claim 2, wherein said print job data further includes a matter number.

4. The method of claim 1, wherein said capturing print job data comprises entering said print job data into a pop-up window during said execution of said print command.

5. The method of claim 1, wherein said capturing print job data comprises gathering at least one of a number of copies, a number of pages, a type of paper, a size of paper or a client identifier associated with said print job.

6. The method of claim 1, wherein said print job includes a plurality of computer files.

7. The method of claim 1, wherein said meta-data comprises markup language.

8. The method of claim 7, wherein said markup language comprises extensible markup language (XML).

9. The method of claim 1, further comprising billing a client in accordance with said print job data.

10. A system for client-side print job meta-data collection and client billing comprising:
a client computer configured for capturing print job data associated with a print job during execution of a print command, converting said print job data into meta-data, combining said meta-data with said print job to form an enhanced print job, and sending said enhanced print job; and
an imaging device in communication with said client computer and configured for receiving said enhanced print job extracting and printing said print job from said enhanced print job and extracting meta-data from said enhanced print job for billing a client.

11. The system of claim 10, wherein said print job data includes number of pages, type of paper, size of paper and client identifying information associated with said print job.

12. The system of claim 10, further comprising a software process running on said client computer for capturing print job data associated with said print job during execution of a print command, converting said print job data into said meta-data, combining said meta-data with said print job to form said enhanced print job, and sending said enhanced print job.

13. The system of claim 10, wherein said imaging device includes one of a printer, a photocopy machine, and a networked printer and a photocopy machine.

14. The system of claim 10, wherein said meta-data comprises a markup language.

15. The system of claim 14, wherein said markup language comprises Extensible Markup Language (XML).

16. The system of claim 10, further comprising a billing computer in communication with said imaging device for receiving said meta-data from said imaging device and configured for generating billing data.

17. The system of claim 16, wherein said billing data computer is further configured for generating billing invoices including said billing data.

18. An imaging system configured for communication with a client computer over a network and configured for receiving an enhanced print job, extracting meta-data from said enhanced print job for billing a client and printing a print job from said enhanced print job.
